(19) United States
(12) Patent Application Publication
(10) Pub. No.: US 2025/0115496 A1
(43) Pub. Date: Apr. 10, 2025

(54) METHODS FOR TREATING PRODUCED WATERS

(71) Applicant: SAUDI ARABIAN OIL COMPANY, Dhahran (SA)

(72) Inventors: Ali A. AL-YOUSEF, Dhahran (SA); Hasmukh A. PATEL, Houston, TX (US); Subhash AYIRALA, Dhahran (SA)

(73) Assignee: SAUDI ARABIAN OIL COMPANY, Dhahran (SA)

(21) Appl. No.: 18/480,946

(22) Filed: Oct. 4, 2023

(51) Int. Cl. C02F 1/52; C02F 101/30; C02F 103/06

(52) U.S. Cl. CPC C02F 1/5236; C02F 2101/30; C02F 2103/06; C02F 2305/14

(57) ABSTRACT

Methods for forming a treated water may comprise: obtaining a produced water comprising at least a divalent metal ion from a subterranean formation; introducing an accelerator into the produced water; wherein the accelerator comprises a zwitterionic compound; introducing a carbon dioxide gas into the produced water; allowing the carbon dioxide gas to react with the divalent metal ion in the presence of the accelerator to form a carbonate salt of the divalent metal ion; and removing the carbonate salt of the divalent metal ion from the produced water to form a treated water having a lower divalent metal ion concentration than the produced water.

### FIELD OF THE DISCLOSURE

The present disclosure relates generally to treating produced waters obtained from subterranean formations and, more particularly, to removing metal ions from produced waters.

### BACKGROUND OF THE DISCLOSURE

Large volumes of water are produced with hydrocarbons in oil and gas fields worldwide—approximately 220 million barrels of water per day globally. The management, handling, and disposal of such vast quantities of produced water pose a serious challenge to the environment in addition to increased energy expenditure for deep disposal. Water is essential for socio-economic development and is a contributing factor in nearly every UN Sustainable Development Goal (SDG). If this produced water may be treated for reuse, the treated water may promote a circular water economy, sustainability, and environmental preservation. However, produced water can be a complex mixture of substances that can include salts, minerals, organic compounds, heavy metals, and other contaminants, thereby complicating reuse thereof.

The composition of produced water may vary depending on the geological characteristics of the reservoir from which the water is extracted, the type of oil or gas produced, and the methods used for extraction. The produced water may commonly have a total dissolved solids concentration of nearly 80,000 ppm in the form of dissolved metal ions. Even higher metal ion concentrations are possible. The high concentration of dissolved metal ions in the produced water may have significant environmental impacts, particularly when the produced water is discharged into surface water systems or is allowed to infiltrate the soil. For example, the high levels of calcium and magnesium in produced waters may lead to increased water hardness, which may cause harm to aquatic organisms and alter the composition of aquatic communities. In addition, the high concentration of metal ions may be toxic to aquatic organisms, leading to reduced growth rates, impaired reproduction, and increased mortality.

Furthermore, the high concentration of metal ions in produced waters may accumulate in soils over time, leading to long-term environmental impacts. The accumulation of these metal ions may cause soil degradation, which can impact the quality of vegetation and reduce the productivity of agricultural lands. The presence of metal ions in soils may additionally pose risks to human health, particularly when the metals are absorbed by plants and are then consumed by humans.

Conventional produced water management strategies aim to minimize the environmental impacts of produced water through disposal, such as by re-injection into deep subterranean formations, or through various treatment methods including sedimentation, coagulation/flocculation, reverse osmosis, electrocoagulation, biological treatments, ion exchange, or membrane distillation. However, these treatment methods are commonly energy intensive and are frequently uneconomical.

### SUMMARY OF THE DISCLOSURE

Various details of the present disclosure are hereinafter summarized to provide a basic understanding. This summary is not an extensive overview of the disclosure and is neither intended to identify certain elements of the disclosure nor to delineate the scope thereof. Rather, the primary purpose of this summary is to present some concepts of the disclosure in a simplified form prior to the more detailed description that is presented hereinafter.

According to embodiments consistent with the present disclosure, methods may comprise obtaining a produced water comprising at least a divalent metal ion from a subterranean formation; introducing an accelerator into the produced water; wherein the accelerator comprises a zwitterionic compound; introducing a carbon dioxide gas into the produced water; allowing the carbon dioxide gas to react with the divalent metal ion in the presence of the accelerator to form a carbonate salt of the divalent metal ion; and removing the carbonate salt of the divalent metal ion from the produced water to form a treated water having a lower divalent metal ion concentration than the produced water.

In other embodiments, methods may comprise obtaining a produced water from a subterranean formation, the produced water having a total dissolved solids concentration of about 50,000 mg/L to about 1,000,000 mg/L and comprising one or more metal ions that comprise a sodium ion, a calcium ion, a magnesium ion, a potassium ion, or any combination thereof; introducing potassium glycinate into the produced water; bubbling a carbon dioxide gas into the produced water; allowing the carbon dioxide gas to react with the one or more metal ions in the presence of the potassium glycinate to form a precipitate comprising a carbonate salt of one or more divalent metal ions; and removing the precipitate from the produced water by filtration to form a treated water having a lower concentration of the one or more divalent metal ions than the produced water.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a non-limiting example of a micelle formed during mineral carbonation.

FIGS. 2A-2C are FTIR spectra of the precipitates formed by the reaction of magnesium chloride with carbon dioxide or magnesium chloride with carbon dioxide in the presence of potassium glycinate.

FIG. 3 is a graph of the thermogravimetric analysis mass loss characteristic curves of the precipitates formed by the reaction of magnesium chloride with carbon dioxide or magnesium chloride with carbon dioxide in the presence of potassium glycinate.

### DETAILED DESCRIPTION

Embodiments in accordance with the present disclosure generally relate to treating produced waters obtained from subterranean formations and, more particularly, to removing metal ions from produced waters through, for example, accelerated carbon dioxide hydration and mineralization methods. As used herein, the term “produced water” refers to water that is produced as a byproduct during the extraction of hydrocarbons. As mentioned previously, the presence of metal ions in produced waters may have significant negative ecological and environmental impacts. Removing these metal ions from the produced waters may allow the reuse or recycle of the water, thus potentially facilitating a circular upstream water economy.

Methods for treating produced waters are described herein. Produced waters containing at least one or more divalent metal ions may be treated with an accelerator and carbon dioxide to form a precipitate comprising a carbonate salt from the reaction of the metal ions with the carbon dioxide. When the reaction occurs in the presence of the accelerator, formation of the precipitate may be encouraged or accelerated. The precipitated carbonate salts (e.g., a divalent carbonate salt) may then be removed from the produced water to form a treated water that has a lower concentration of one or more divalent metal ions than does the produced water. After removing the precipitated carbonate salts, the treated water may be further processed or used in other applications.

The treatment methods disclosed herein involve carbon dioxide hydration and mineralization to remove at least divalent metal ions from produced waters to produce treated waters that have a lower divalent metal ion concentration than do the produced waters themselves. Carbon dioxide hydration is facilitated by introducing a carbon dioxide gas to the produced water at a desired rate for a desired amount of time. Carbon dioxide hydration is followed by mineralization of at least the divalent metal ions (e.g., Ca²⁺, Mg²⁺, Ba²⁺). Additional metal ions, such as monovalent metal ions (e.g., Na⁺ or K⁺) may remain within the produced water, as monovalent metal carbonate salts are considerably more soluble than are divalent metal carbonates. Without being bound by theory or mechanism, the mineralization is believed to be governed by the rate and stability of the thermodynamic activity of the bicarbonate ions generated after the carbon dioxide contacts the produced waters.

The metal ion in the produced water may, for example, comprise a monovalent metal ion (e.g., Na⁺ and/or K⁺) or a divalent metal ion (e.g., Ca²⁺, Mg²⁺, and/or Ba²⁺). Preferably, the metal ions undergoing formation of a precipitate comprises a divalent metal ion. Divalent metal ions, when reacted with carbon dioxide in the presence of the precipitate, may form highly insoluble carbonate salts (e.g., CaCO₃, MgCO₃, and/or, BaCO₃) that may be easily separated from the produced water to form the treated water.

A concentration of the divalent metal ions in the produced water may be sufficiently high as to precipitate a solid once reacted with the carbon dioxide gas in the presence of the accelerator. That is, the divalent metal ion may be present in the produced water at a concentration above the divalent metal ion's carbonate salt solubility product constant in water at a temperature of interest.

An accelerator may be used in the treatment methods to increase the rate of carbon dioxide hydration and mineralization to quickly and efficiently remove the metal ions in the form of carbonate salts. For example, accelerators may generate carbonate or bicarbonate species upon interacting with carbon dioxide to promote a rapid transformation from CO₂ to a carbonate minerals. The reaction of the metal ion into a carbonate salt of the metal ion may follow the reaction scheme of Formulas 1 and 2 below,

$$E + {CO}_{2} + {H}_{2} O ↔ {E H}^{+} + {HCO}_{{3}^{-}} α {M}_{β} X γ + {E H}^{+} + {HCO}_{{3}^{-}} \to {M}_{δ} {CO}_{3} + ε {H}_{ζ} X + E \qquad Equations 1 and 2$$

in which E is the accelerator, M is the metal ion (monovalent or divalent), and X is a monovalent (e.g., chloride or hydroxide) or divalent (e.g., sulfate) anion. In the instance that M comprises a divalent cation and X comprises a monovalent anion, α is 1, β is 1, γ is 2, δ is 1, ε is 2, and ζ is 1. When M comprises a divalent cation and X comprises a divalent anion, α is 1, β is 1, γ is 1, δ is 1, ε is 1, and ζ is 2. When M comprises a monovalent cation and X comprises a monovalent anion, α is 2, β is 1, γ is 1, δ is 2, ε is 2, and ζ is 1. When M comprises a monovalent cation and X comprises a divalent anion, α is 1, β is 2, γ is 1, β is 2, ε is 1, and ζ is 2.

As shown above, the reaction to form the carbonate salt of the metal ion, MCO₃ in the case of a divalent metal ions, comprises two steps. In the first step, carbon dioxide is hydrated to produce bicarbonate anions within the micelles formed by the accelerator. As the bicarbonate anions migrate outside the micelles, the bicarbonate anions react with the metal ion (in the form of a metal salt) to form the carbonate salt of the metal ion. In the case of a divalent metal ion, the divalent metal carbonate forms a precipitate that may then be removed from the produced water. After removal of the divalent metal carbonate, the produced water may have a lower concentration of the divalent metal ion than was initially present.

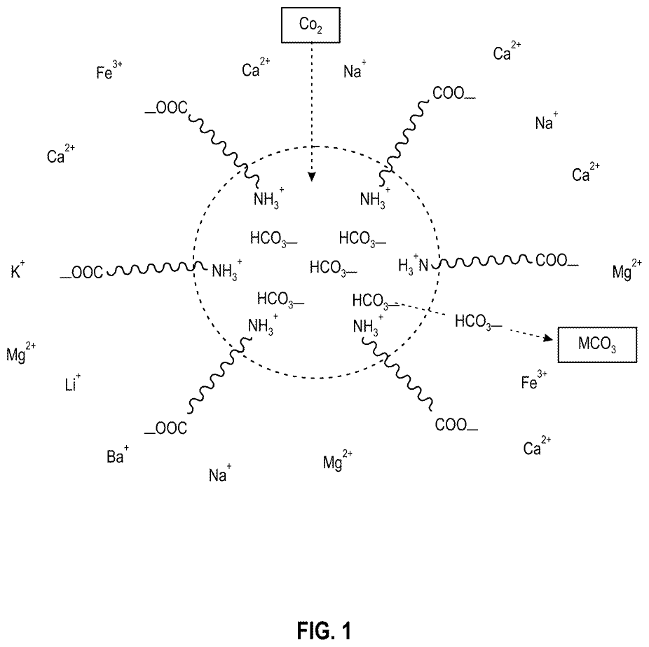

The accelerator may comprise a zwitterionic compound, such that the positively and negatively charged groups of the molecule will form micelles when dissolved in the produced water. Preferred accelerators have both carboxylic acid (—COOH) and amino (NH₂) functionalities, and as a result, can form micelles in the high salinity water in the presence of carbon dioxide. FIG. 1 is a non-limiting example of a micelle formed during mineral carbonation. The presence of micelles in the produced water may accelerate the formation of bicarbonate ions upon the introduction of a carbon dioxide gas into the produced water, thus stabilizing the produced water for subsequent mineralization of the divalent metal ions in the produced water.

Without being bound by theory or mechanism, the micelle is believed to provide the residence time for CO₂ to accelerate bicarbonate formation and to stabilize the fluid state to aid in subsequent mineralization with available metal ions in the produced water. The mineralized carbonates obtained from the process can be separated using filtration or other separation techniques for salt recovery and help achieve a circular water economy. Additionally, the carbonation of the metal ions may take place without the formation of micelles as long as the accelerator generates an intermediate species suitable to promote formation of a carbonate salt.

The accelerator used in the present disclosure may be any suitable molecule that contains positively and negatively charged groups (e.g., a zwitterion). For example, the accelerator may comprise an amino acid or an amino acid salt, such as an amino acid salt of sodium and/or potassium. Examples of such amino acids include alanine, arginine, asparagine, aspartate, cysteine, glutamine, glutamate, glycine, histidine, isoleucine, leucine, lysine, methionine, phenylalanine, proline, serine, threonine, tryptophan, tyrosine, valine, or any combination thereof. Potassium glycinate is an illustrative accelerator that may be used. Alternately, the accelerator may comprise amines including monoethanolamine, piperazine-based secondary or primary amines, alkyl or aromatic amines, the like, and any combination thereof.

In a non-limiting example, the accelerator may be potassium glycinate and the divalent metal ion may be a calcium cation present within calcium chloride. In this instance, the carbonate salt formed in accordance with Formula 1 would be calcium carbonate, a low-solubility precipitate.

In some embodiments of the present disclosure, the methods may comprise: obtaining a produced water having a total dissolved solids concentration of about 50,000 mg/L to about 1,000,000 mg/L and comprising one or more metal ions from a subterranean formation; wherein the one or more metal ions comprise a sodium ion, a calcium ion, a magnesium ion, a potassium ion, or a combination thereof; introducing potassium glycinate into the produced water; bubbling a carbon dioxide gas into the produced water at a desired flow rate and for a desired time; allowing the carbon dioxide gas to react with the one or more metal ions in the presence of the potassium glycinate, such as at a temperature of about 25° C. to about 75° C., to form a precipitate comprising a carbonate salt of one or more divalent metal ions; and removing the precipitate from the produced water by filtration to form a treated water having a lower concentration of the one or more divalent metal ions than the produced water.

The produced waters of the present disclosure may contain a high concentration of dissolved solids. For example, the produced water may have a total dissolved solids concentration of about 50,000 mg/mL to about 1,000,000 mg/L, or about 50,000 mg/L to about 500,000 mg/L, or about 50,000 mg/L to about 250,000 mg/L, or about 50,000 mg/L to about 100,000 mg/L, or about 100,000 mg/L to about 1,000,000 mg/L, or about 100,000 mg/L to about 500,000 mg/L, or about 100,000 mg/L to about 250,000 mg/L, or about 250,000 mg/L to about 1,000,000 mg/L, or about 250,000 mg/L to about 500,000 mg/L, or about 500,000 mg/L to about 1,000,000 mg/L.

The dissolved solids may be in the form of dissolved cations and/or anions of various minerals. The metal ions in the produced water may, for example, comprise a sodium ion, a calcium ion, a magnesium ion, a potassium ion, or a combination thereof. Sodium ions may account for a majority of the total dissolved solids in the produced water. For example, a concentration of sodium ions in the produced water may be about 10,000 mg/L to about 100,000 mg/L, or about 10,000 mg/L to about 80,000 mg/L, or about 10,000 mg/L to about 60,000 mg/L, or about 10,000 mg/L to about 40,000 mg/L, or about 10,000 mg/L to about 20,000 mg/L, or about 20,000 mg/L to about 100,000 mg/L, or about 20,000 mg/L to about 80,000 mg/L, or about 20,000 mg/L to about 60,000 mg/L, or about 20,000 mg/L to about 40,000 mg/L, or about 40,000 mg/L to about 100,000 mg/L, or about 40,000 mg/L to about 80,000 mg/L, or about 40,000 mg/L to about 60,000 mg/L, or about 60,000 mg/L to about 100,000 mg/L, or about 60,000 mg/L to about 80,000 mg/L, or about 80,000 mg/L to about 100,000 mg/L.

Furthermore, the metal ions in the produced water may comprise at least one or more divalent metal ions, such as calcium ions, magnesium ions, barium ions, or any combination thereof. A concentration of calcium ions in the produced water may, for example, be about 1,000 mg/L to about 10,000 mg/L, or about 1,000 mg/L to about 8,000 mg/L, or about 1,000 mg/L to about 6,000 mg/L, or about 1,000 mg/L to about 4,000 mg/L, or about 1,000 mg/L to about 2,000 mg/L, or about 2,000 mg/L to about 10,000 mg/L, or about 2,000 mg/L to about 8,000 mg/L, or about 2,000 mg/L to about 6,000 mg/L, or about 2,000 mg/L to about 4,000 mg/L, or about 4,000 mg/L to about 10,000 mg/L, or about 4,000 mg/L to about 8,000 mg/L, or about 4,000 mg/L to about 6,000 mg/L, or about 6,000 mg/L to about 10,000 mg/L, or about 6,000 mg/L to about 8,000 mg/L, or about 8,000 mg/L to about 10,000 mg/L.

A concentration of magnesium ions in the produced water may, for example, be about 100 mg/L to about 5,000 mg/L, or about 100 mg/L to about 1,000 mg/L, or about 100 mg/L to about 800 mg/L, or about 100 mg/L to about 600 mg/L, or about 100 mg/L to about 400 mg/L, or about 100 mg/L to about 200 mg/L, or about 200 mg/L to about 5,000 mg/L, or about 200 mg/L to about 1,000 mg/L, or about 200 mg/L to about 800 mg/L, or about 200 mg/L to about 600 mg/L, or about 200 mg/L to about 400 mg/L, or about 400 mg/L to about 5,000 mg/L, or about 400 mg/L to about 1,000 mg/L, or about 400 mg/L to about 800 mg/L, or about 400 mg/L to about 600 mg/L, or about 600 mg/L to about 5,000 mg/L, or about 600 mg/L to about 1,000 mg/L, or about 600 mg/L to about 800 mg/L, or about 800 mg/L to about 5,000 mg/L, or about 800 mg/L to about 1,000 mg/L, or about 1,000 mg/L to about 5,000 mg/L.

A concentration of potassium ions in the produced water may, for example, be about 100 mg/L to about 5,000 mg/L, or about 100 mg/L to about 1,000 mg/L, or about 100 mg/L to about 800 mg/L, or about 100 mg/L to about 600 mg/L, or about 100 mg/L to about 400 mg/L, or about 100 mg/L to about 200 mg/L, or about 200 mg/L to about 5,000 mg/L, or about 200 mg/L to about 1,000 mg/L, or about 200 mg/L to about 800 mg/L, or about 200 mg/L to about 600 mg/L, or about 200 mg/L to about 400 mg/L, or about 400 mg/L to about 5,000 mg/L, or about 400 mg/L to about 1,000 mg/L, or about 400 mg/L to about 800 mg/L, or about 400 mg/L to about 600 mg/L, or about 600 mg/L to about 5,000 mg/L, or about 600 mg/L to about 1,000 mg/L, or about 600 mg/L to about 800 mg/L, or about 800 mg/L to about 5,000 mg/L, or about 800 mg/L to about 1,000 mg/L, or about 1,000 mg/L to about 5,000 mg/L.

In addition to these cations, the produced water may further comprise anions such as a chloride anion, a bicarbonate anion, a sulfate anion, or any combination thereof. For example, the produced water may have a concentration of chloride anions of about 10,000 mg/L to about 100,000 mg/L, or about 10,000 mg/L to about 80,000 mg/L, or about 10,000 mg/L to about 60,000 mg/L, or about 10,000 mg/L to about 40,000 mg/L, or about 10,000 mg/L to about 20,000 mg/L, or about 20,000 mg/L to about 100,000 mg/L, or about 20,000 mg/L to about 80,000 mg/L, or about 20,000 mg/L to about 60,000 mg/L, or about 20,000 mg/L to about 40,000 mg/L, or about 40,000 mg/L to about 100,000 mg/L, or about 40,000 mg/L to about 80,000 mg/L, or about 40,000 mg/L to about 60,000 mg/L, or about 60,000 mg/L to about 100,000 mg/L, or about 60,000 mg/L to about 80,000 mg/L, or about 80,000 mg/L to about 100,000 mg/L.

A concentration of bicarbonate anions in the produced water may, for example, be about 10 mg/L to about 1,000 mg/L, or about 10 mg/L to about 800 mg/L, or about 10 mg/L to about 600 mg/L, or about 10 mg/L to about 400 mg/L, or about 10 mg/L to about 200 mg/L, or about 10 mg/L to about 100 mg/L, or about 100 mg/L to about 1,000 mg/L, or about 100 mg/L to about 800 mg/L, or about 100 mg/L to about 600 mg/L, or about 100 mg/L to about 400 mg/L, or about 100 mg/L to about 200 mg/L, or about 200 mg/L to about 1,000 mg/L, or about 200 mg/L to about 800 mg/L, or about 200 mg/L to about 600 mg/L, or about 200 mg/L to about 400 mg/L, or about 400 mg/L to about 1,000 mg/L, or about 400 mg/L to about 800 mg/L, or about 400 mg/L, to about 600 mg/L, or about 600 mg/L to about 1,000 mg/L, or about 600 mg/L to about 800 mg/L, or about 800 mg/L to about 1,000 mg/L.

A concentration of sulfate anions in the produced water may, for example, be about 100 mg/L to about 10,000 mg/L, or about 100 mg/L to about 8,000 mg/L, or about 100 mg/L to about 6,000 mg/L, or about 100 mg/L to about 4,000 mg/L, or about 100 mg/L to about 2,000 mg/L, or about 100 mg/L to about 1,000 mg/L, or about 1,000 mg/L to about 10,000 mg/L, or about 1,000 mg/L to about 8,000 mg/L, or about 1,000 mg/L to about 6,000 mg/L, or about 1,000 mg/L to about 4,000 mg/L, or about 1,000 mg/L to about 2,000 mg/L, or about 2,000 mg/L to about 10,000 mg/L, or about 2,000 mg/L to about 8,000 mg/L, or about 2,000 mg/L to about 6,000 mg/L, or about 2,000 mg/L to about 4,000 mg/L, or about 4,000 mg/L to about 10,000 mg/L, or about 4,000 mg/L to about 8,000 mg/L, or about 4,000 mg/L to about 6,000 mg/L, or about 6,000 mg/L to about 10,000 mg/L, or about 6,000 mg/L to about 8,000 mg/L, or about 8,000 mg/L to about 10,000 mg/L.

Carbon dioxide gas may be introduced into the produced water using a variety of suitable methods, preferably by bubbling. The carbon dioxide gas may be introduced into the produced water as a continuous process, although pulsed or discontinuous introduction processes may also be suitable. For example, the carbon dioxide gas may be introduced into the produced water at a flow rate of about 1 mL/min to about 10 mL/min, or about 1 mL/min to about 8 mL/min, or about 1 mL/min to about 6 mL/min, or about 1 mL/min to about 4 mL/min, or about 1 mL/min to about 2 mL/min, or about 2 mL/min to about 10 mL/min, or about 2 mL/min to about 8 mL/min, or about 2 mL/min to about 6 mL/min, or about 2 mL/min to about 4 mL/min, or about 4 mL/min to about 10 mL/min, or about 4 mL/min to about 8 mL/min, or about 4 mL/min to about 6 mL/min, or about 6 mL/min to about 10 mL/min, or about 6 mL/min to about 8 mL/min, or about 8 mL/min to about 10 mL/min.

Furthermore, the carbon dioxide gas may be introduced into the produced water for a period of time sufficient to allow the reaction of the divalent metal ion to form a carbonate salt. For example, the carbon dioxide gas may be introduced into the produced water for a period of time of about 30 minutes to about 1 hour, or about 30 minutes to about 50 minutes, or about 30 minutes to about 40 minutes, or about 40 minutes to about 1 hour, or about 40 minutes to about 50 minutes, or about 50 minutes to about 1 hour.

The temperature of the reaction may be selected such that the reaction occurs at a desired rate. For example, the reaction may occur at a temperature of about 25° C. to about 75° C., or about 25° C. to about 65° C., or about 25° C. to about 55° C., or about 25° C. to about 45° C., or about 25° C. to about 35° C., or about 35° C. to about 75° C., or about 35° C. to about 65° C., or about 35° C. to about 55° C., or about 35° C. to about 45° C., or about 45° C. to about 75° C., or about 45° C. to about 65° C., or about 45° C. to about 55° C., or about 55° C. to about 75° C., or about 55° C. to about 65° C., or about 65° C. to about 75° C.

Following the reaction, the carbonate salt of the divalent metal ion may be removed from the produced water by any suitable removal method. For example, the carbonate salt may be removed from the produced water by filtration, such as by a disc filter, a horizontal belt filter, a rotary drum filter, a table filter, a tilting pan filter, a tray filter, or a vacuum filter. Alternate removal methods may include, but are not limited, to settling, centrifugation, cyclonic separation, or any combination thereof.

Embodiments disclosed herein include:

A. Methods for forming a treated water. The methods comprise: obtaining a produced water comprising at least a divalent metal ion from a subterranean formation; introducing an accelerator into the produced water; wherein the accelerator comprises a zwitterionic compound; introducing a carbon dioxide gas into the produced water; allowing the carbon dioxide gas to react with the divalent metal ion in the presence of the accelerator to form a carbonate salt of the divalent metal ion; and removing the carbonate salt of the divalent metal ion from the produced water to form a treated water having a lower divalent metal ion concentration than the produced water.

B. Methods for forming a treated water. The methods comprise: obtaining a produced water from a subterranean formation, the produced water having a total dissolved solids concentration of about 50,000 mg/L to about 1,000,000 mg/L and comprising one or more metal ions that comprise a sodium ion, a calcium ion, a magnesium ion, a potassium ion, or any combination thereof; introducing potassium glycinate into the produced water; bubbling a carbon dioxide gas into the produced water; allowing the carbon dioxide gas to react with the one or more metal ions in the presence of the potassium glycinate to form a precipitate comprising a carbonate salt of one or more divalent metal ions; and removing the precipitate from the produced water by filtration to form a treated water having a lower concentration of the one or more divalent metal ions than the produced water.

Each of embodiments A and B may have one or more of the following additional elements in any combination:

Element 1: wherein the reaction of the carbon dioxide gas with the divalent metal ion takes place in the presence of micelles formed from the accelerator.

Element 2: wherein the produced water has a total dissolved solids concentration of about 50,000 mg/L to about 1,000,000 mg/L.

Element 3: wherein the divalent metal ion comprises a calcium ion, a magnesium ion, or any combination thereof.

Element 4: wherein the produced water has a concentration of sodium ions of about 10,000 mg/L to about 100,000 mg/L, a concentration of calcium ions of about 1,000 mg/L to about 10,000 mg/L, a concentration of magnesium ions of about 100 mg/L to about 5,000 mg/L, and a concentration of potassium ions of about 100 mg/L to about 5,000 mg/L.

Element 5: wherein the produced water further comprises a chloride anion, a bicarbonate anion, a sulfate anion, or any combination thereof.

Element 6: wherein the produced water has a concentration of chloride anions of about 10,000 mg/L to about 100,000 mg/L, a concentration of bicarbonate anions of about 10 mg/L to about 1,000 mg/L, and a concentration of sulfate anions of about 100 mg/L to about 10,000 mg/L.

Element 7: wherein the accelerator comprises an amino acid salt.

Element 8: wherein the amino acid salt is a sodium salt or a potassium salt.

Element 9: wherein the amino acid salt comprises potassium glycinate.

Element 10: wherein the carbon dioxide gas is introduced into the produced water by bubbling.

Element 11: wherein the carbon dioxide gas is introduced into the produced water at a flow rate of about 1 mL/min to about 10 mL/min.

Element 12: wherein the carbon dioxide gas is introduced into the produced water for a period of time ranging from about 30 min to about 1 hour.

Element 13: wherein the reaction of the carbon dioxide gas with the divalent metal ion is at a temperature of about 25° C. to about 75° C.

Element 14: wherein the carbonate salt of the divalent metal ion is removed from the produced water by filtration.

By way of non-limiting example, exemplary combinations applicable to A and B include, but are not limited to: 1 and 2; 1 and 3; 1 and 4; 1 and 5; 1 and 6; 1 and 7; 1 and 8; 1 and 9; 1 and 10; 1 and 11; 1 and 12; 1 and 13; 1 and 14; 2 and 3; 2 and 4; 2 and 5; 2 and 6; 2 and 7; 2 and 8; 2 and 9; 2 and 10; 2 and 11; 2 and 12; 2 and 13; 2 and 14; 3 and 4; 3 and 5; 3 and 6; 3 and 7; 3 and 8; 3 and 9; 3 and 10; 3 and 11; 3 and 12; 3 and 13; 3 and 14; 5 and 6; 5 and 7; 5 and 8; 5 and 9; 5 and 10; 5 and 11; 5 and 12; 5 and 13; 5 and 14; 6 and 7; 6 and 8; 6 and 9; 6 and 10; 6 and 11; 6 and 12; 6 and 13; 6 and 14; 7 and 8; 7 and 9; 7 and 10; 7 and 11; 7 and 12; 7 and 13; 7 and 14; 10 and 11; 10 and 12; 10 and 13; 10 and 14; 11 and 12; 11 and 13; 11 and 14; 12 and 13; 12 and 14; 13 and 14; 1-3; 1-4; 1-5; 1-6; 1-7; 1-8; 1-9; 1-10; 1-11; 1-12; 1-13; 1-14; 2-4; 2-5; 2-6; 7-9; 10-12; 10-13; 10-14; and 12-14.

The present disclosure is further directed to the following non-limiting clauses:
Clause 1. A method comprising:
   obtaining a produced water comprising at least a divalent metal ion from a subterranean formation;
   introducing an accelerator into the produced water;
      wherein the accelerator comprises a zwitterionic compound;
   introducing a carbon dioxide gas into the produced water;
   allowing the carbon dioxide gas to react with the divalent metal ion in the presence of the accelerator to form a carbonate salt of the divalent metal ion; and
   removing the carbonate salt of the divalent metal ion from the produced water to form a treated water having a lower divalent metal ion concentration than the produced water.
Clause 2. The method of clause 1, wherein the reaction of the carbon dioxide gas with the divalent metal ion takes place in the presence of micelles formed from the accelerator.
Clause 3. The method of clause 1 or clause 2, wherein the produced water has a total dissolved solids concentration of about 50,000 mg/L to about 1,000,000 mg/L.
Clause 4. The method of any one of clauses 1-3, wherein the divalent metal ion comprises a calcium ion, a magnesium ion, or any combination thereof.
Clause 5. The method of clause 4, wherein the produced water has a concentration of sodium ions of about 10,000 mg/L to about 100,000 mg/L, a concentration of calcium ions of about 1,000 mg/L to about 10,000 mg/L, a concentration of magnesium ions of about 100 mg/L to about 5,000 mg/L, and a concentration of potassium ions of about 100 mg/L to about 5,000 mg/L.
Clause 6. The method of any one of clauses 1-5, wherein the produced water further comprises a chloride anion, a bicarbonate anion, a sulfate anion, or any combination thereof.
Clause 7. The method of clause 6, wherein the produced water has a concentration of chloride anions of about 10,000 mg/L to about 100,000 mg/L, a concentration of bicarbonate anions of about 10 mg/L to about 1,000 mg/L, and a concentration of sulfate anions of about 100 mg/L to about 10,000 mg/L.
Clause 8. The method of any one of clauses 1-7, wherein the accelerator comprises an amino acid salt.
Clause 9. The method of clause 8, wherein the amino acid salt is a sodium salt or a potassium salt.
Clause 10. The method of clause 8 or clause 9, wherein the amino acid salt comprises potassium glycinate.
Clause 11. The method of any one of clauses 1-10, wherein the carbon dioxide gas is introduced into the produced water by bubbling.
Clause 12. The method of any one of clauses 1-11, wherein the carbon dioxide gas is introduced into the produced water at a flow rate of about 1 mL/min to about 10 mL/min.
Clause 13. The method of any one of clauses 1-12, wherein the carbon dioxide gas is introduced into the produced water for a period of time ranging from about 30 min to about 1 hour.
Clause 14. The method of any one of clauses 1-13, wherein the reaction of the carbon dioxide gas with the divalent metal ion is at a temperature of about 25° C. to about 75° C.
Clause 15. The method of any one of clauses 1-14, wherein the carbonate salt of the divalent metal ion is removed from the produced water by filtration.
Clause 16. A method comprising:
   obtaining a produced water from a subterranean formation, the produced water having a total dissolved solids concentration of about 50,000 mg/L to about 1,000,000 mg/L and comprising one or more metal ions that comprise a sodium ion, a calcium ion, a magnesium ion, a potassium ion, or any combination thereof;
   introducing potassium glycinate into the produced water;
   bubbling a carbon dioxide gas into the produced water;
   allowing the carbon dioxide gas to react with the one or more metal ions in the presence of the potassium glycinate to form a precipitate comprising a carbonate salt of one or more divalent metal ions; and
   removing the precipitate from the produced water by filtration to form a treated water having a lower concentration of the one or more divalent metal ions than the produced water.
Clause 17. The method of clause 16, wherein the reaction of the carbon dioxide gas with the one or more divalent metal ions takes place in the presence of micelles formed from the potassium glycinate.
Clause 18. The method of clause 16 or clause 17, wherein the carbon dioxide gas is bubbled into the produced water at a flow rate of about 1 mL/min to about 10 mL/min.
Clause 19. The method of any one of clauses 16-18, wherein the carbon dioxide gas is bubbled into the produced water for about 30 min to about 1 hour.
Clause 20. The method of any one of clauses 16-19, wherein the carbon dioxide gas is reacted with the one or more divalent metal ions at a temperature of about 25° C. to about 75° C.

### EXAMPLES

Samples of sandstone powder (approximately 1.9 g) were loaded into a reaction vessel with 0.5 g or 1 g of calcium chloride or magnesium chloride in a 5 wt % or 10 wt % aqueous solution, respectively. For control samples, carbon dioxide gas was bubbled through the calcium chloride or magnesium chloride solution at a rate of 5 mL/min for 45 minutes at 50° C. without any accelerator present. For experimental samples, one molar equivalent of potassium glycinate was added to the calcium chloride or magnesium chloride samples before bubbling in carbon dioxide under the same conditions. After 45 minutes, the sandstone powder was filtered from each aqueous sample and dried at 110° C. The sandstone powder was then weighed to determine if additional minerals (in the form of carbonate salts) were present following the reactions. Table 1 summarizes the results of these experiments.

TABLE 1

| | CaCl₂ Solutions | | | MgCl₂ Solutions | | |
|---|---|---|---|---|---|---|
| | | Exp. | Exp. | | Exp. | Exp. |
| | Control | Sample | Sample | Control | Sample | Sample |
| | Sample | 1 | 2 | Sample | 1 | 2 |
| Initial | 1.92 | 1.92 | 1.92 | 1.91 | 1.91 | 1.91 |
| mass of | | | | | | |
| sandstone | | | | | | |
| (g) | | | | | | |
| Mass of | 1 | 0.5 | 1 | 1 | 0.5 | 1 |
| CaCl₂ or | | | | | | |
| MgCl₂ | | | | | | |
| added (g) | | | | | | |
| Mass of | 1.02 | 0.51 | 1.02 | 1.19 | 0.59 | 1.19 |
| potassium | | | | | | |
| glycinate | | | | | | |
| added (g) | | | | | | |
| Final mass | 1.92 | 2.19 | 2.38 | 1.91 | 1.98 | 2.09 |
| of sand- | | | | | | |
| stone + | | | | | | |
| carbonate | | | | | | |
| salt (g) | | | | | | |
| Percent | — | 14% | 24% | — | 3.7% | 9.4% |
| Increase | | | | | | |

As shown in Table 1, the experimental samples of aqueous calcium chloride and magnesium chloride, after reacting with the carbon dioxide in the presence of potassium glycinate, both are believed to have produced solid precipitates. The control samples appeared to exhibit no change in mass and, therefore, produced no precipitate or such a small amount that measurement was not practicable.

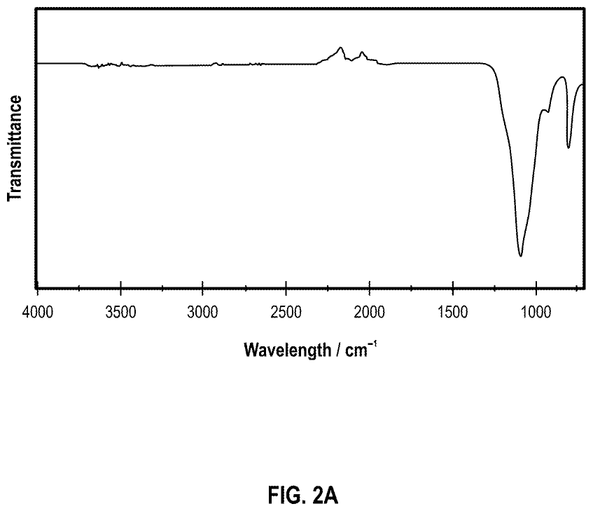

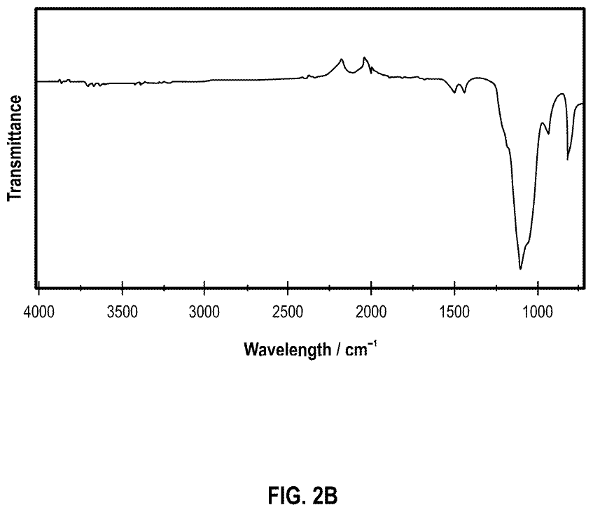

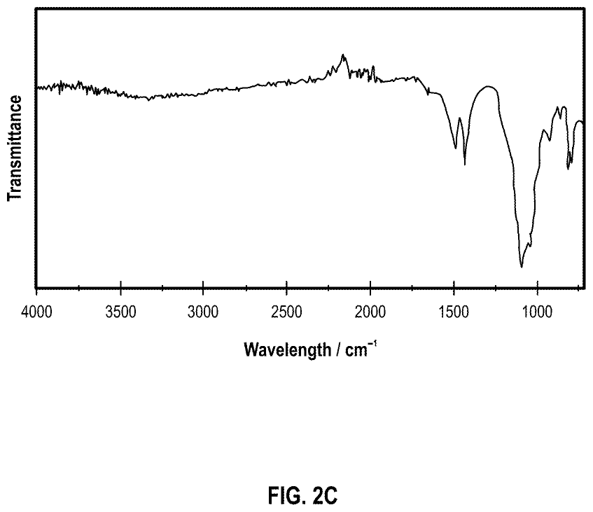

FTIR spectroscopy was conducted using an Agilent Cary 630 FTIR Spectrometer. FIGS. 2A-2C show FTIR spectra of the final control and experimental samples, respectively, for the reactions of magnesium chloride. Experimental samples 1 and 2 showed peaks at 1480 cm⁻¹, 1419 cm⁻¹, and 851 cm⁻¹, representing the —CO₃ vibration of magnesium carbonate. The peak at 1081 cm⁻¹ in the spectra for the control and experimental samples is associated with the Si—O—Si stretching vibration of sandstone. The control spectrum does not show any peaks for magnesium carbonate.

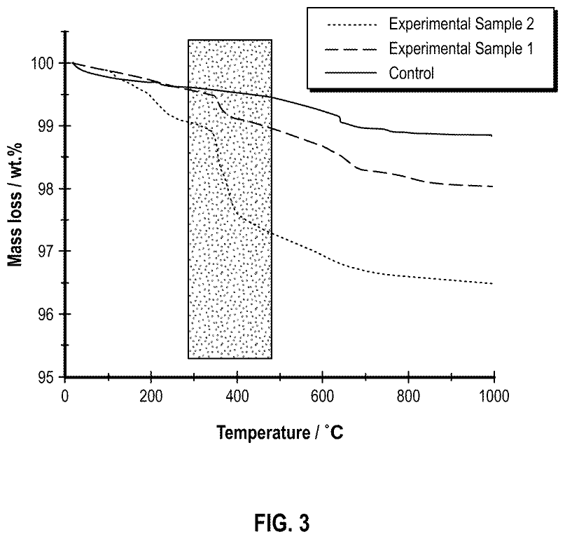

Thermogravimetric characteristic analysis was conducted using a TA Instruments SDT Q600™ thermogravimetric analyzer. The control and experimental samples for the magnesium chloride reactions were heated to 1000° C. with a 10° C./min heating rate underflow of nitrogen gas (50 mL/min). FIG. 3 shows the mass loss patterns of the final control and experimental samples collected by the thermogravimetric analyzer. The initial mass loss from the samples at temperatures up to 120° C. is associated with loss of adsorbed water. The experimental samples also show mass loss between 200° C. and 300° C., which may be attributed to strongly bound or structural water molecules in magnesium carbonate. The decomposition of magnesium carbonate occurs between 400° C. and 500° C. Experimental sample 2 demonstrates a mass loss within this temperature range, indicating the presence of magnesium carbonate. These results, in addition to the FTIR spectra, suggest that using potassium glycinate as an accelerator facilitates the mineralization of carbonate salts from the reaction of carbon dioxide and metal ions (e.g., calcium and magnesium).

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized that these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element, or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

The invention claimed is:

1. A method comprising:
obtaining a produced water comprising at least a divalent metal ion from a subterranean formation;
introducing an accelerator into the produced water;
wherein the accelerator comprises a zwitterionic compound;
introducing a carbon dioxide gas into the produced water;
allowing the carbon dioxide gas to react with the divalent metal ion in the presence of the accelerator to form a carbonate salt of the divalent metal ion; and
removing the carbonate salt of the divalent metal ion from the produced water to form a treated water having a lower divalent metal ion concentration than the produced water.

2. The method of claim 1, wherein the reaction of the carbon dioxide gas with the divalent metal ion takes place in the presence of micelles formed from the accelerator.

3. The method of claim 1, wherein the produced water has a total dissolved solids concentration of about 50,000 mg/L to about 1,000,000 mg/L.

4. The method of claim 1, wherein the divalent metal ion comprises a calcium ion, a magnesium ion, or any combination thereof.

5. The method of claim 4, wherein the produced water has a concentration of sodium ions of about 10,000 mg/L to about 100,000 mg/L, a concentration of calcium ions of about 1,000 mg/L to about 10,000 mg/L, a concentration of magnesium ions of about 100 mg/L to about 5,000 mg/L, and a concentration of potassium ions of about 100 mg/L to about 5,000 mg/L.

6. The method of claim 1, wherein the produced water further comprises a chloride anion, a bicarbonate anion, a sulfate anion, or any combination thereof.

7. The method of claim 6, wherein the produced water has a concentration of chloride anions of about 10,000 mg/L to about 100,000 mg/L, a concentration of bicarbonate anions of about 10 mg/L to about 1,000 mg/L, and a concentration of sulfate anions of about 100 mg/L to about 10,000 mg/L.

8. The method of claim 1, wherein the accelerator comprises an amino acid salt.

9. The method of claim 8, wherein the amino acid salt is a sodium salt or a potassium salt.

10. The method of claim 9, wherein the amino acid salt comprises potassium glycinate.

11. The method of claim 1, wherein the carbon dioxide gas is introduced into the produced water by bubbling.

12. The method of claim 1, wherein the carbon dioxide gas is introduced into the produced water at a flow rate of about 1 mL/min to about 10 mL/min.

13. The method of claim 1, wherein the carbon dioxide gas is introduced into the produced water for a period of time ranging from about 30 min to about 1 hour.

14. The method of claim 1, wherein the reaction of the carbon dioxide gas with the divalent metal ion is at a temperature of about 25° C. to about 75° C.

15. The method of claim 1, wherein the carbonate salt of the divalent metal ion is removed from the produced water by filtration.

16. A method comprising:
obtaining a produced water from a subterranean formation, the produced water having a total dissolved solids concentration of about 50,000 mg/L to about 1,000,000 mg/L and comprising one or more metal ions that comprise a sodium ion, a calcium ion, a magnesium ion, a potassium ion, or any combination thereof;
introducing potassium glycinate into the produced water;
bubbling a carbon dioxide gas into the produced water;
allowing the carbon dioxide gas to react with the one or more metal ions in the presence of the potassium glycinate to form a precipitate comprising a carbonate salt of one or more divalent metal ions; and
removing the precipitate from the produced water by filtration to form a treated water having a lower concentration of the one or more divalent metal ions than the produced water.

17. The method of claim 16, wherein the reaction of the carbon dioxide gas with the one or more divalent metal ions takes place in the presence of micelles formed from the potassium glycinate.

18. The method of claim 16, wherein the carbon dioxide gas is bubbled into the produced water at a flow rate of about 1 mL/min to about 10 mL/min.

19. The method of claim 16, wherein the carbon dioxide gas is bubbled into the produced water for about 30 min to about 1 hour.

20. The method of claim 16, wherein the carbon dioxide gas is reacted with the one or more divalent metal ions at a temperature of about 25° C. to about 75° C.
